(19) United States
(12) Patent Application Publication
(10) Pub. No.: US 2005/0173869 A1
(43) Pub. Date: Aug. 11, 2005

(54) Spark plug tube seal

(75) Inventor: John Brian Wagner, Greenfield, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership

(21) Appl. No.: 11/049,494

(22) Filed: Feb. 2, 2005

Related U.S. Application Data
(60) Provisional application No. 60/542,995, filed on Feb. 9, 2004.

(51) Int. Cl. F16L 17/00

(52) U.S. Cl. 277/602

(57) ABSTRACT

A seal adapted to sealingly engage an outer member and an inner member in an installed position includes a first portion, a second portion and an intermediate portion. The first portion is adapted to sealingly engage a sealing surface of the outer member in the installed position. The second portion is adapted to sealingly engage the inner member in the installed position. The intermediate portion extends between the first and second portions. The first portion includes an outboard surface engaging the sealing surface of the outer member and a first overlap portion extending outwardly beyond an inner diameter of the sealing surface.

### CROSS-REFERENCE TO RELATED APPLICATIONS

This application claims the benefit of U.S. Provisional Application No. 60/542,995, filed on Feb. 9, 2004. The disclosure of the above application is incorporated herein by reference.

### FIELD OF THE INVENTION

The present invention relates to seals and more particularly to a spark plug tube seal having a seal configuration provided on an outer diameter and an inner diameter.

### BACKGROUND OF THE INVENTION

Conventional spark plug tube seals incorporate a rubber outer dimension (OD) for engaging a bore and may have various inner dimension (ID) seal configurations for engaging a shaft. Such conventional spark plug tube seals are intended to provide air tight sealing up to around 2.5 mm shaft to bore offset.

In some instances, the seals are installed manually by inserting the seal into the bore. Typically, sealing forces provided at the OD of the seal and the ID of the seal are proportional to an installation force. More specifically, a greater installation force is necessary to install a seal having a greater sealing capacity on its ID and OD.

### SUMMARY OF THE INVENTION

A seal adapted to sealingly engage an outer member and an inner member in an installed position includes a first portion, a second portion and an intermediate portion. The first portion is adapted to sealingly engage a sealing surface of the outer member in the installed position. The second portion is adapted to sealingly engage the inner member in the installed position. The intermediate portion extends between the first and second portions. The first portion includes an outboard surface engaging the sealing surface of the outer member and a first overlap portion extending outwardly beyond an inner diameter of the sealing surface.

According to additional features a first annular ring is disposed in the first portion. A second annular ring is disposed in the second portion. The annular rings comprise a rigid material such as metal. The first portion of the seal defines a second overlap portion extending outwardly beyond said inner diameter of the sealing surface. The first and second overlap portions overlap opposite ends of the sealing surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a seal according to the present teachings and shown engaged to an inner shaft;

FIG. 2 is a detailed sectional view of a portion of the seal illustrated in FIG. 1;

FIG. 2a is a sectional view of the seal of FIG. 1 shown in an installed position sealingly engaged to the inner shaft and an outer member;

FIG. 3 is a sectional view of a seal constructed in accordance to additional features of the present invention;

FIG. 4 is a detailed sectional view of a seal constructed in accordance to additional features of the present invention;

FIG. 5 is a detailed sectional view of a seal constructed in accordance to additional features of the present invention;

FIG. 6 is a sectional view of the seal of FIG. 5 shown in an installed position;

FIG. 7 is a sectional view of a seal constructed in accordance to additional features and shown in an installed position;

FIG. 8 is a sectional view of a seal constructed in accordance to additional features and shown in an installed position; and

FIG. 9 is a sectional view of a seal constructed in accordance to additional features and shown in an installed position;

### DETAILED DESCRIPTION OF THE PREFERRED EMBODIMENTS

The following description of the embodiment(s) is merely exemplary in nature and is in no way intended to limit the invention, its application, or uses.

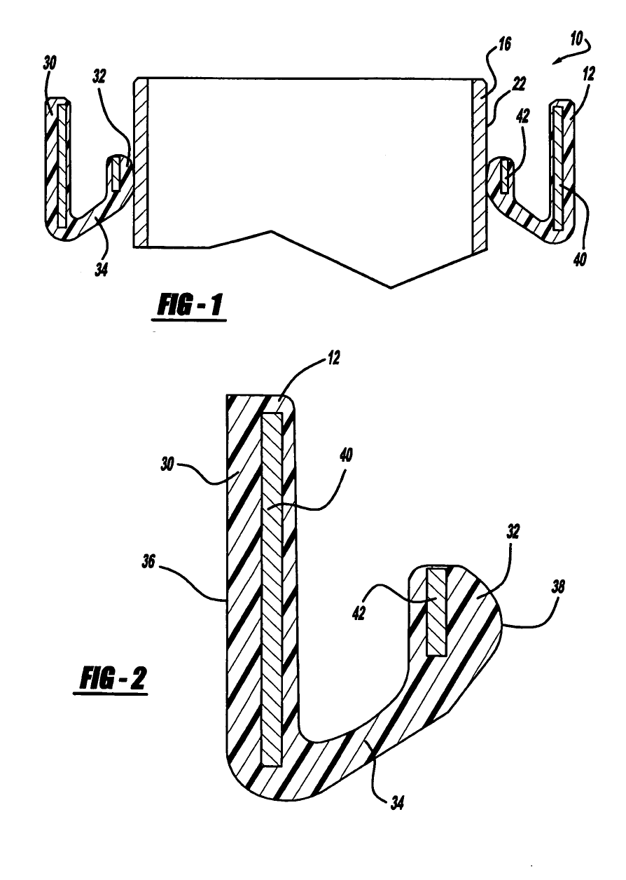

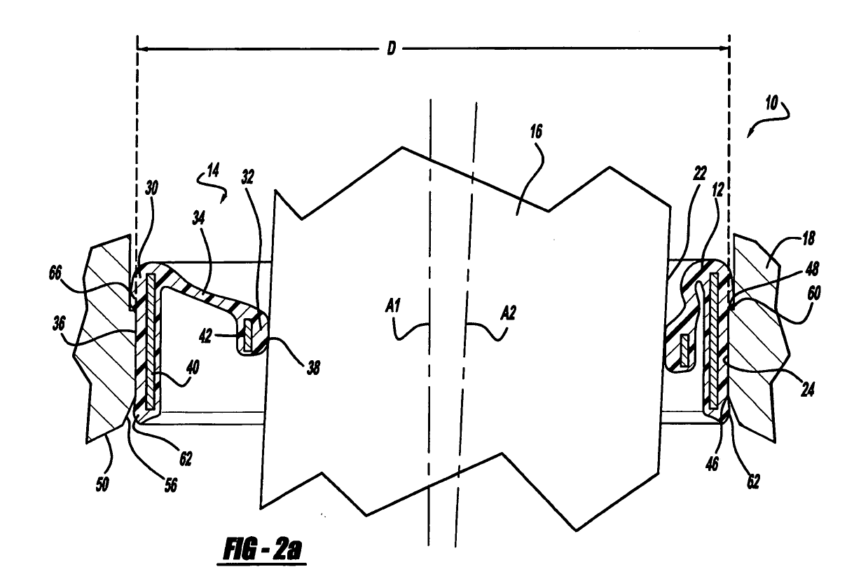

With initial reference to FIGS. 1-2a an arrangement for sealing an annular space is shown and generally identified at reference numeral 10. The arrangement 10 generally includes a seal 12 disposed in an annular space 14 (FIG. 2a) defined between an inner member 16 and an outer member 18. During operation, the seal 12 engages respective sealing surfaces 22 and 24 on the inner and outer members 16 and 18, respectively in an installed position (FIG. 2a). For purposes of discussion the inner member 16 will be referred to herein as a shaft while the outer member 18 will be referred to herein as a bore. It is appreciated that while the specific examples provided herein relate to a spark plug tube seal arrangement having a shaft and a bore, the teachings may be similarly applicable to other sealing arrangements and are not limited to a spark plug tube seal.

With specific reference now to FIGS. 1 and 2, the seal 12 will be described in greater detail. In general, the seal 12 includes a first portion 30, a second portion 32 and an intermediate portion 34 extending between the first portion 30 and the second portion 32. The first portion 30 is radially offset outwardly relative to the second portion 32. The first portion 30 defines an outboard sealing surface 36 for engaging the sealing surface 24 of the bore 18 (FIG. 2a) in an installed position. Similarly, the second portion 32 defines an inboard sealing surface 38 for engaging the sealing surface 22 of the shaft 16 in an installed position. The intermediate portion 34 generally defines a conical contour. The outboard and inboard sealing surfaces 36 and 38 of the seal 12 may be made of an elastomeric material such as rubber although other materials may be used.

The outboard sealing surface 36 of the seal 12 generally defines a cylindrical face. The inboard sealing surface 38 of the seal 12 generally defines an arcuate contour. As will be described in greater detail herein, the second portion 32 is adapted to deflect with the inner member 16 (FIG. 2a) and maintain contact with the inner member 16 upon movement of the inner member 16 relative the outer member 18.

The first portion 30 of the seal 12 includes a first annular ring 40 disposed therein. The second portion 32 of the seal 12 includes a second annular ring 42 disposed therein. The annular rings 40 and 42 may be made of a rigid material such as metal. The annular rings 40 and 42 provide rigidity to the respective first and second portions 30 and 32 and to the seal 12 as a whole.

With specific reference now to FIG. 2a the seal 12 and its interaction with the bore 18 in an installed position will be described. The seal 12 provides barb-like retention properties at an interface with the bore 18 to resist axial movement of the seal 12 relative to the bore 18. The bore 18 interfaces the first portion 30 of the seal 12 at the outboard sealing surface 36. The bore 18 defines a first radial edge 46 at an installation end 50 and a second radial edge 48 at an opposite end. At the installation end 50 of the bore 18, the first radial edge 46 leads to a chamfer 56 for facilitating installation of the seal 12 relative the bore 18 in a direction upward as viewed from FIG. 2a. The chamfer 56 guides the seal 12 into the annular space 14 during installation. On the opposite end of the bore 18 the second radial edge 48 leads to a transverse lip 60.

As shown in FIG. 2a, the seal 12 defines a first overlap portion 62 extending outwardly at the first radial edge 46 beyond an inner diameter D defined by the sealing surface 24 of the bore 18 in the installed position. Similarly, a second overlap portion 66 extends outwardly at the second radial edge 48 beyond the inner diameter D of the sealing surface 24 of the bore 18. The overlap portions 62 and 66 resist axial movement of the seal 12 along an axis of the bore 18 in the installed position. The first and second radial edge 46 and 48 provide the barb-like retention properties onto the outboard sealing surface 36 of the seal 12. As a result, the seal 12 maintains the installed position over time. It is appreciated that the chamfer 56 and the transverse lip 60 may comprise other geometries while allowing the seal 12 to overlap beyond the inner diameter of the sealing surface 24 of the bore 18.

With continued reference to FIG. 2a, the seal 12 accommodates lateral and angular movement of the shaft 16 relative to an axis of the bore 18 while maintaining a seal at an interface between the inboard sealing surface 38 of the seal 12 and the sealing surface 22 of the shaft 16. In FIG. 2a the shaft 16 is shown moved from an axis A1 laterally rightward and rotated in the clockwise direction to an axis A2. The second portion 32 of the seal 12 moves complementary to movement of the shaft 16. To maintain an interface between the seal 12 and the shaft 16, the intermediate portion 34 stretches on a first portion and buckles on an opposite portion. It is appreciated that the intermediate portion 34 may comprise a greater slope between the first portion 30 and the second portion 32 to accommodate further deflection and/or rotation of the shaft 16. While the seal 12 is shown deflected laterally and rotated, it is appreciated that the seal 12 may experience one of lateral deflection or rotation exclusively in the installed position or, alternatively, not experience any movement.

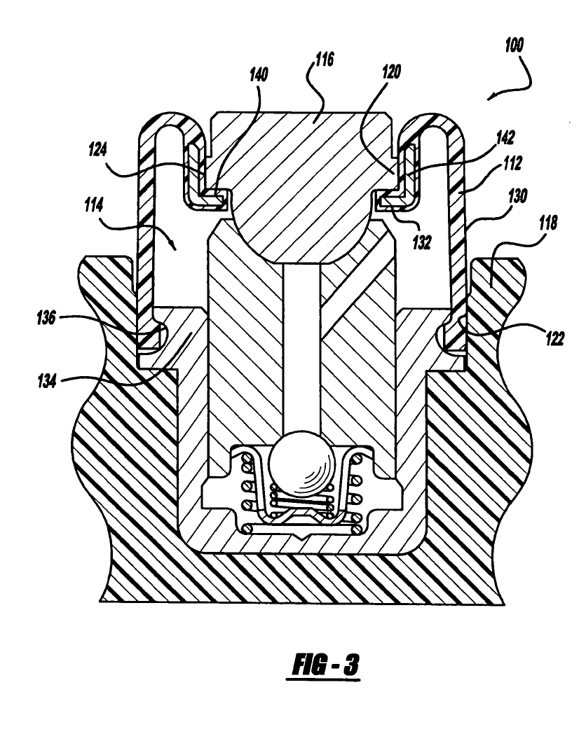

With reference now to FIG. 3, an arrangement for sealing an annular space according to additional features is shown and generally identified at reference numeral 100. The arrangement 100 generally includes a seal 112 disposed in an annular space 114 defined between an inner member 116 and an outer member 118. The inner member 116 generally defines a collar 120. In operation, the seal 112 engages respective sealing surfaces 122 and 124 on the inner and outer members 116 and 118, respectively in an installed position. More specifically, a first portion 130 engages the sealing surface 122 and a second portion 132 engages the sealing surface 124. The first portion 130 is secured between the outer member 118 and an inner housing 134 having an annular groove 136.

The seal 112 includes an annular lip 140 for mating with the sealing surface 124 around a first end of the collar 120 of the inner member 116. The seal 112 may be made of an elastomeric material such as rubber. An annular ring 142 is arranged within the annular lip 140. The annular ring 142 may be made of a rigid material such as metal.

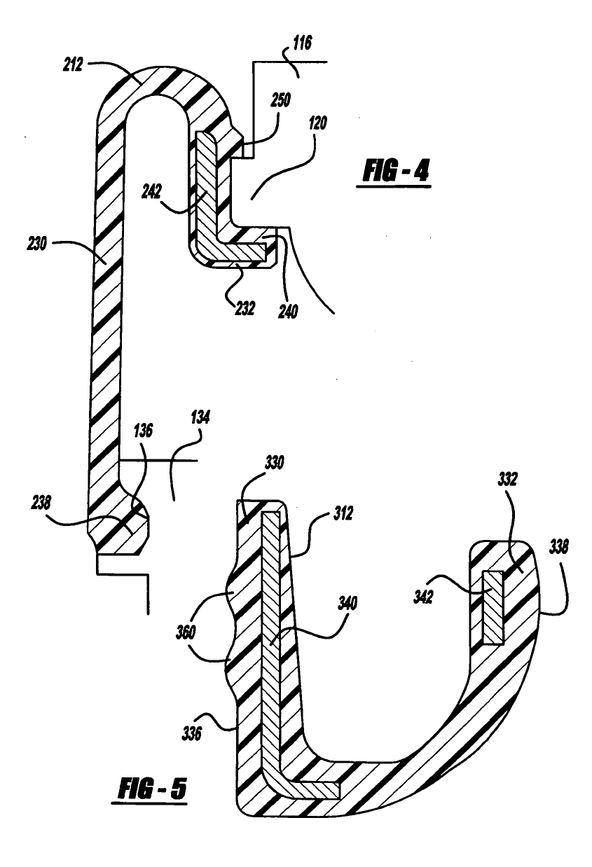

FIG. 4 is a cross-sectional view of a seal 212 according to additional features of the present invention. The seal 212 generally comprises the geometrical configuration of the seal 112 illustrated in FIG. 3 including a first portion 230, a second portion 232 and an annular ring 242. The seal 212 additionally includes a barb 250 arranged on a first end to complement an annular lip 240. In an installed position, the barb 250 and the annular lip 240 cooperate to capture the collar 120 in an installed position. In addition, an end of the first portion 230 of the seal 212 defines an annular foot portion 238 for nesting within the groove 136 defined on the inner housing 134.

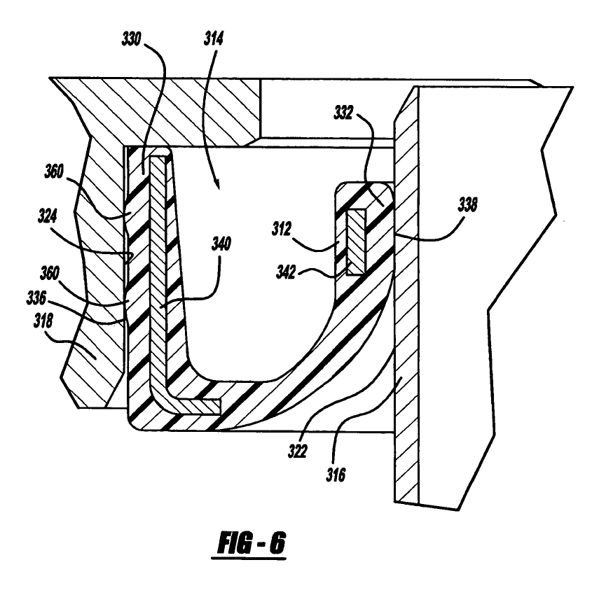

With reference now to FIGS. 5 and 6, a seal 312 according to additional features is shown. The seal 312 is adapted to form a seal between an annular space 314 defined between an inner member 316 and an outer member 318. The inner member 316 defines a sealing surface 322. The outer member 318 defines a sealing surface 324. The seal 312 generally comprises a first portion 330 having an outboard sealing surface 336 (FIG. 5) adapted to engage the sealing surface 324 of the outer member 318. The seal 312 further includes a second portion 332 having an inboard sealing surface 338 (FIG. 5) adapted to engage the sealing surface 322 of the inner member 316 in an installed position. Radial rings 340 and 342 are arranged in the first and second portions 330 and 332 respectively.

A pair of ribs 360 are arranged radially around the outboard sealing surface 336 of the first portion 330. The ribs 360 encourage a seal between the outboard sealing surface 336 of the seal 312 and the sealing surface 324 of the outer member 318. It is appreciated that additional or fewer ribs 360 may be arranged along the outboard sealing surface 336. It is further appreciated that ribs may be additionally provided at any location along the inboard and outboard sealing surfaces defined on any of the seals disclosed herein.

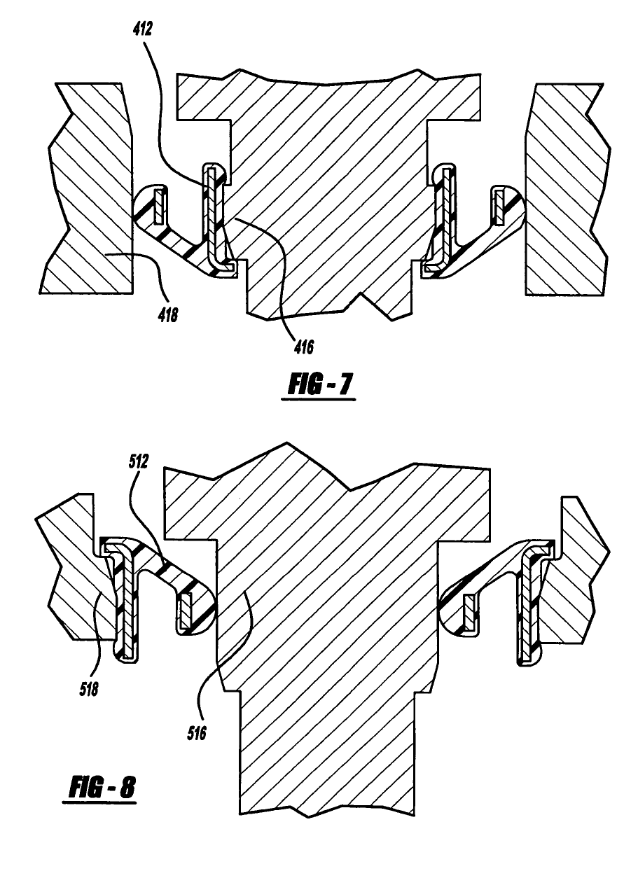

With reference now to FIG. 7, a seal 412 according to additional features is shown. The seal 412 is adapted to form a seal between an inner member 416 and an outer member 418. The seal 412 incorporates the barb-like retention properties as described herein at an interface with the inner member 416 to resist axial movement of the seal 412 relative to the inner member 416.

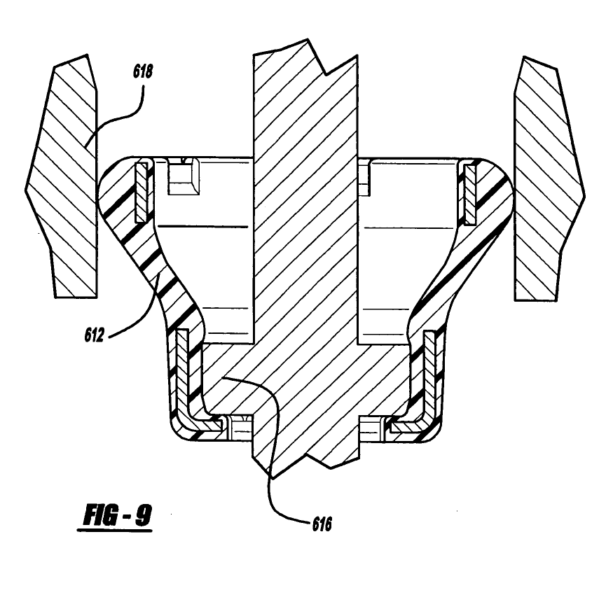

FIG. 8 illustrates a seal 512 according to additional features. The seal 512 is adapted to form a seal between an inner member 516 and an outer member 518. The seal 512 incorporates the barb-like retention properties as described herein at an interface with the outer member 518.

FIG. 9 illustrates a seal 612 according to additional features. The seal 612 is adapted to form a seal between an inner member 616 and an outer member 618. The seal 612 incorporates the barb-like retention properties as described herein at an interface with the inner member 616.

The seals 412 and 612 incorporate an annular lip arranged on an inner sealing surface for engaging the inner member 416 and 616 respectively. The annular lips of the seals 412 and 612 are similar to the annular lips 140 and 240 associated with seals 112 and 212 respectively. Seal 512 incorporates the annular lip on an outboard sealing surface for engaging the outer member 518.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A seal adapted to sealingly engage an outer member and an inner member in an installed position, the seal comprising:
a first portion adapted to sealingly engage a sealing surface of the outer member in the installed position;
a second portion adapted to sealingly engage the inner member in the installed position; and
an intermediate portion extending between said first and second portions;
wherein said first portion includes an outboard surface engaging said sealing surface of said outer member and a first overlap portion extending outwardly beyond an inner diameter of said sealing surface.

2. The seal of claim 1, further comprising a first annular ring disposed in said first portion.

3. The seal of claim 2, further comprising a second annular ring disposed in said second portion.

4. The seal of claim 3 wherein said first and second annular ring comprise metallic material.

5. The seal of claim 4 wherein outer surfaces of said seal comprise a rubber material.

6. The seal of claim 1 wherein said first portion defines a second overlap portion extending outwardly beyond said inner diameter of said sealing surface, wherein said first and second overlap portions overlap opposite radial ends of said sealing surface.

7. The seal of claim 1 wherein said intermediate portion defines a conical contour.

8. The seal of claim 5 wherein said first portion defines at least one radial rib formed therearound and adapted to engage said sealing surface of the outer member in the installed position.

9. A seal adapted to sealingly engage an outer member and an inner member in an installed position, the seal comprising:
a first portion adapted to sealingly engage a sealing surface of the outer member in the installed position;
a second portion adapted to sealingly engage the inner member in the installed position; and
an intermediate portion extending between said first and second portions;
wherein said second portion is adapted to deflect with the inner member and maintain contact therewith upon movement of said inner member relative the outer member.

10. The seal of claim 1, further comprising a first annular ring disposed in said first portion.

11. The seal of claim 10, further comprising a second annular ring disposed in said second portion.

12. The seal of claim 11 wherein said first and second annular ring comprise metallic material.

13. The seal of claim 12 wherein outer surfaces of said seal comprise a rubber material.

14. The seal of claim 9 wherein said first portion defines a first overlap portion extending outwardly beyond an inner diameter of said sealing surface.

15. The seal of claim 9 wherein said intermediate portion defines a conical contour.

16. The seal of claim 9 wherein said first portion defines at least one radial rib formed therearound and adapted to engage said sealing surface of the outer member in the installed position.

17. A mounting arrangement for a seal comprising:
an outer member defining an outer sealing surface;
an inner member offset radially inward from said outer member and defining an inner sealing surface; and
a seal interposed between said inner and outer member in an installed position and comprising:
a first portion adapted to sealingly engage said outer sealing surface of said outer member in the installed position;
a second portion adapted to sealingly engage the inner member in the installed position; and
an intermediate portion extending between said first and second portions;
wherein said outer member defines a first and second radial edge at opposite ends of said sealing surface and wherein said first portion of said seal includes first and second overlap portions extending around said first and second radial edge outwardly beyond an inner diameter of said sealing surface.

18. The seal of claim 17, further comprising a first annular ring disposed in said first portion.

19. The seal of claim 18, further comprising a second annular ring disposed in said second portion.

20. The seal of claim 19 wherein said first and second annular ring comprise metallic material.

21. A mounting arrangement for a seal comprising:
an outer member defining an outer sealing surface;
an inner housing disposed adjacent said outer member;
an inner member offset radially inward from said outer member and defining an inner sealing surface; and
a seal interposed between said inner and outer member in an installed position and comprising:
a first portion adapted to sealingly engage said outer sealing surface of said outer member and said inner housing in the installed position;
a second portion adapted to sealingly engage the inner member in the installed position; and
an intermediate portion extending between said first and second portions.

22. The mounting arrangement of claim 21 wherein said inner housing defines an annular groove.

23. The mounting arrangement of claim 22 wherein said first portion of said seal defines a foot and wherein said foot is adapted to nest between said annular groove and said outer sealing surface of said outer member.

24. A seal adapted to sealingly engage an outer member and an inner member in an installed position, the seal comprising:
a first portion adapted to sealingly engage a sealing surface of the inner member in the installed position;
a second portion adapted to sealingly engage the outer member in the installed position; and
an intermediate portion extending between said first and second portions;
wherein said first portion includes an inboard surface engaging said sealing surface of said inner member and a first overlap portion extending inwardly beyond an outer diameter of said sealing surface.

25. The seal of claim 24, further comprising a first annular ring disposed in said first portion.

26. The seal of claim 25, further comprising a second annular ring disposed in said second portion.

27. The seal of claim 26 wherein said first and second annular ring comprise metallic material.

28. The seal of claim 27 wherein outer surfaces of said seal comprise a rubber material.
